(19) United States
(12) Patent Application Publication
(10) Pub. No.: US 2017/0057702 A1
(43) Pub. Date: Mar. 2, 2017

(54) BAG CONSTRUCTION WITH REINFORCED HANDLES

(71) Applicants: David Simhaee, Los Angeles, CA (US); Ebrahim Simhaee, Los Angeles (US); Josh Simhaee, Los Angeles, CA (US)

(72) Inventors: David Simhaee, Los Angeles, CA (US); Ebrahim Simhaee, Los Angeles (US); Josh Simhaee, Los Angeles, CA (US)

(21) Appl. No.: 15/242,759

(22) Filed: Aug. 22, 2016

Related U.S. Application Data
(60) Provisional application No. 62/210,194, filed on Aug. 26, 2015.

(51) Int. Cl. B65D 33/02; B31B 1/86; B65D 33/10

(52) U.S. Cl. CPC B65D 33/02; B65D 33/105; B31B 1/86; B31B 2219/9077; B31B 2219/9096; B31B 2221/20

(57) ABSTRACT

A bag construction is disclosed of the type having handles and a patch for reinforcing the attachment between the handles and the walls of the bag. The exemplary reinforcement patch includes a fold-over to define a folded top edge of the patch. During construction, a patch having the folded top end is placed in registry with the two ends of the handle that are attached to the wall of the paper bag such that the top edge is generally perpendicular to the ends of the handle. The patch is then affixed over the handle and exterior surface of the bag using glue or other such permanent adhesives. According to a salient aspect, the reinforcing patches are configured to resist tearing, particularly when shear forces are applied that normally act to detach the handles away from the side of the bag.

### TECHNICAL FIELD OF THE INVENTION

This patent application relates generally to the field of bags and, in particular, paper bag constructions having handle reinforcement patches.

### BACKGROUND OF THE INVENTION

Among known paper bag constructions are paper bags that have handles. Some bags of this construction include a patch to reinforce the attachment of the handle to the wall of the bag. The patch has been used both on the inside of the bag when the handle is attached to the inside wall of the bag, and on the outside of the bag when the handle is attached to the outside wall of the bag. The majority of the paper bag constructions which have a reinforcement patch are for bags having handles on the inside of the bag. This is illustrated in U.S. Pat. No. 3,439,591A, for example. To this day, the reinforcement of handles using a patch over an outside wall of a paper bag has been subject to a structural weakness at the periphery of the patch that still has such bags prone to tearing, especially when a shear force is applied to the peripheral edge of the patch.

As such, it is desirable to provide a paper bag with reinforced handle and bag connection using a patch that is less prone to tearing. It is with respect to these and other considerations that the present disclosure is made.

### SUMMARY OF THE INVENTION

According to an aspect of the present invention, there is provided a paper bag construction having reinforced handle attachments. The paper bag construction comprises a bag body having a top end and an opposing bottom end and one or more side walls extending between the bottom end and the top end in a vertical direction. The one or more sidewalls define a hollow interior of the bag body that is closed at the bottom end and open at the top end. The paper bag construction also includes a handle affixed to an exterior surface of the bag body at a first attachment area and a second attachment area proximate to the top end of the bag body. The handle extending from the first and second attachment areas in the vertical direction beyond the top end of the bag body. The paper bag construction also includes a reinforcing patch overlaying the first and second attachment areas, wherein the reinforcing patch is affixed to both the handle and the exterior surface of the bag body. In addition, the reinforcing patch comprises a sheet of material that is folded-over to define a top edge. Moreover, the reinforcing patch is affixed such that the top edge is oriented generally perpendicular to the vertical direction and the folded-over top edge is proximate to the top end of the bag body.

According to another aspect of the present invention, there is provided a method for constructing a paper bag with reinforced handle attachments. The method includes the steps of providing a bag body. The bag body includes a top end an opposing bottom end and one or more side walls extending between the bottom end and the top end in a vertical direction. The one or more sidewalls define a hollow interior of the bag body that is closed at the bottom end and open at the top end. The method also includes the step of adhering a first and a second end portion of an elongate handle to an exterior surface of the bag body. The handle is adhered proximate to the top end of the bag body at a first attachment area and a second attachment area, respectively, such that the handle is configured to extend from the first and second attachment areas generally in the vertical direction beyond the top end of the bag body. The method also includes the step of folding a first section of a sheet of material over a second section of the sheet to define a reinforcing patch having a folded-over top edge and applying an adhesive to an inside surface of the folded-over reinforcing patch. The method also includes the step of placing the reinforcing patch in registry with the handle such that the patch overlays the first and second attachment areas and the folded-over top edge is oriented generally perpendicular to the vertical direction and is proximate to the top end of the bag body. The method also includes the step of affixing the reinforcing patch to the handle and the exterior surface of the bag body. The reinforcing patch is adhered to an outside surface of the handle and portions of the exterior surface of the bag body that are adjacent to the first and second attachment areas.

These and other aspects, features, and advantages can be appreciated from the accompanying description of certain embodiments of the invention and the accompanying drawing figures and claims.

### BRIEF DESCRIPTION OF THE DRAWINGS

FIG. 1 illustrates a conventional paper bag construction;

FIG. 2 illustrates a conventional paper bag construction with a handle;

FIG. 3 illustrates a conventional paper bag construction having a handle and a conventional patch;

FIG. 4 illustrates the paper bag of FIG. 2 in use;

FIG. 5A illustrates an exemplary configuration of a reinforcement patch according to an embodiment of the present invention;

FIG. 5B illustrates the paper bag construction having a handle and the patch of FIG. 5A according to an embodiment of the present invention;

FIG. 6 illustrates the paper bag of FIG. 2 in use;

FIG. 7 illustrates a paper bag construction with handles and a conventional patch; and

FIG. 8 illustrates a paper bag construction with a handle and the reinforcement patch of FIG. 5A according to an embodiment of the present invention.

### DETAILED DESCRIPTION OF CERTAIN EMBODIMENTS OF THE INVENTION

By way of overview and introduction, a bag construction is disclosed of the type having handles and a patch for reinforcing the attachment between the handles and the walls of the bag. According to a salient aspect, the reinforcing patches are configured to resist tearing, particularly when shear forces are applied that normally act to detach the handles away from the side of the bag.

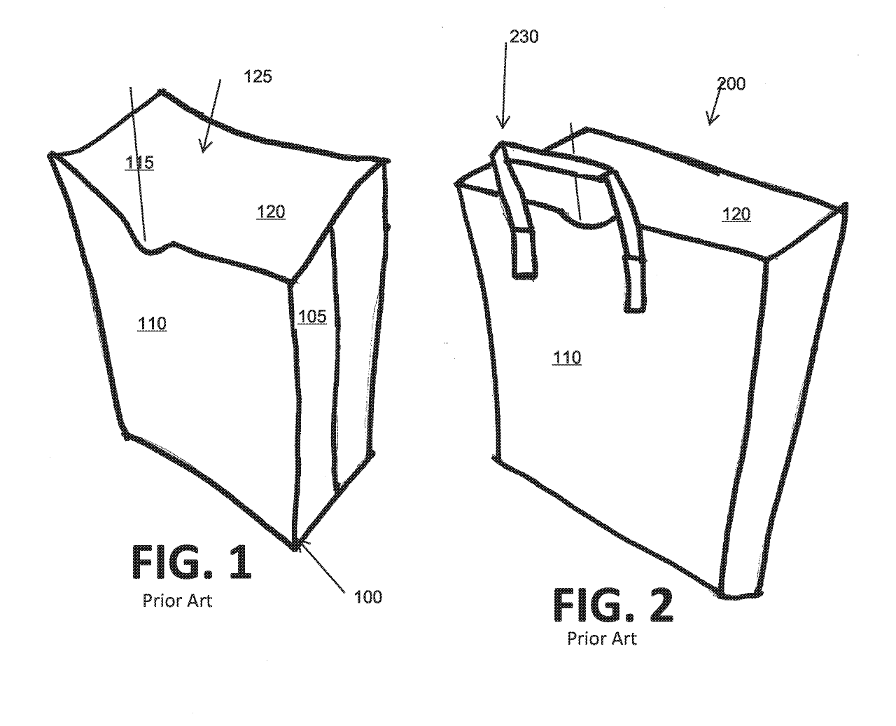

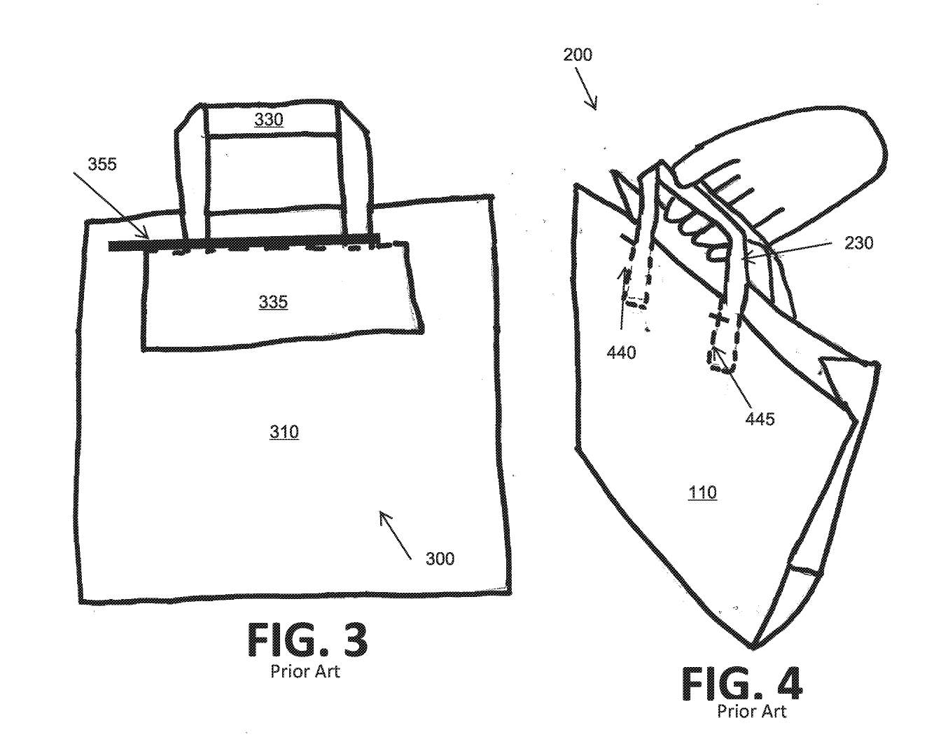

FIG. 1 depicts a traditional paper bag 100 used for packaging and carrying of goods. The paper bag has four walls (105, 110, 115 and 120), a closed bottom (not shown) and a mouth 125 that is open, as shown in FIG. 1. FIG. 2 illustrates a paper bag 200 (e.g., as in bag 100 of FIG. 1) with a handle 230 attached to an outside of a wall 110 of the bag near the mouth 120. As shown in FIG. 3, a patch 335 that reinforces the attachment of the handle 330 to the wall 310 can be applied to a typical bag 300 having handles. The patch has been used both on the inside of the bag when the handle is attached to the inside wall of the bag, and on the outside of the bag when the handle is attached to the outside wall of the bag (as shown in FIG. 3).

Conventional reinforcement of the handles by the patch 335 over the connection between the handle 330 and the outside of the wall 310 of the paper bag has been attendant with an inherent structural weakness, when forces are applied to the connection between the handle and the bag that try to pull the handle in a direction away from the wall of the bag (i.e., a “shear force”). This can occur, for example, when a weighted bag is picked up by a single handle.

FIG. 4 is a picture illustrating the paper bag 200 of FIG. 2 picked up by both handles. As shown, when the paper bag 200 is picked up with both handles together, the handles stay parallel to the walls of the bag. In this situation, both the handles and walls of the bag stay generally perpendicular to the ground. As a result, all of the force on the attachment points of the handles to the wall of the bag is distributed over a surface of the attachment area. In particular, the forces are distributed over the entire surface area of each of the attachment point(s) 440, 445 between the handle 230 and the wall 110 of the bag 100. Generally, the handles do not tear or separate from the body of the bag in response to this kind of lifting, even with 10 kg of weight inside the bag, unless the body of the bag itself tears.

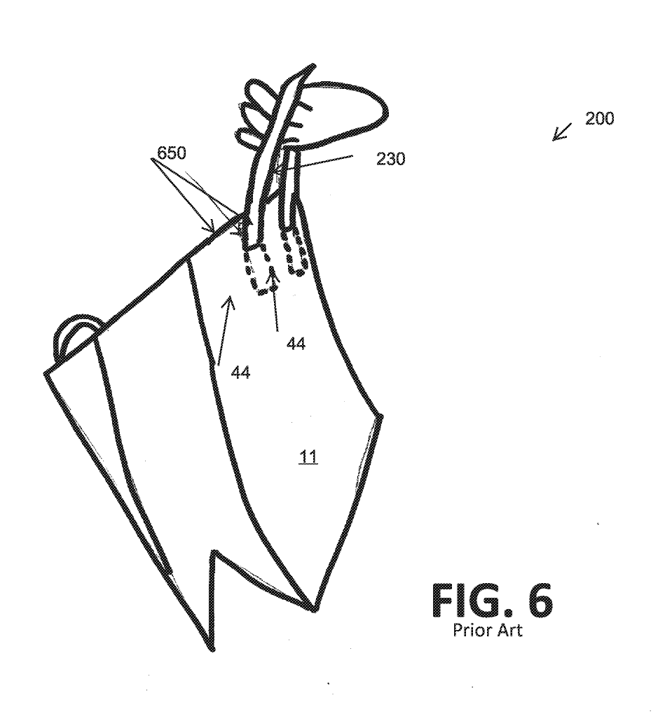

However, sometimes, the user picks up the bag with one handle. In this scenario, the handle stays perpendicular to the ground and forms, for example, a 30-60 degree angle relative to the body of the bag. FIG. 6 is a diagram illustrating the paper bag 200 of FIG. 2 picked up by a single handle 230, with weight inside the bag and showing the resulting orientation of the bag due to the forces on the handle and the connection point(s) 440, 445 between the wall 110 and the handle. As a result, all of the force is focused on the one upper edge 650 of the points of attachment between the handle 230 and the wall 110 of the bag (i.e., at the uppermost part of the attachment 445 where the handle 230 emerges), rather than along the entire surface area of the attachment point. The edge 650 has a much smaller surface area to distribute the force and, as a result, and the separation force between the handle and the wall is greatest at that location. As a consequence, even with a considerably less amount of weight inside the bag than the bag is capable of holding, the handle attachment can fail. Tests have shown that such conventional bag and handle attachments separate with 4 kg weight inside the bag even though the bag was capable of holding 10 kg when picked up by both handles. When the upper line of attachment between handle and body of paper tears, then the successive portions of the attachment will tear in a cascading effect, separating the handle from the body of the bag.

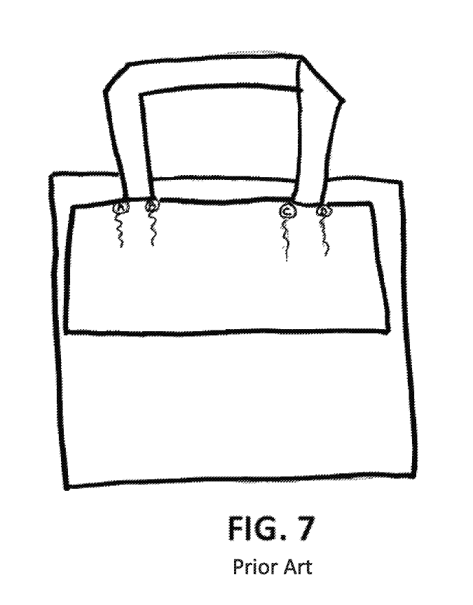

A prior art approach to addressing this weakness has been to place a patch over the handle attachment point for reinforcement. FIG. 3 shows a paper bag 300 having a reinforcing patch affixed to the outside of the handle and the outside wall 310 of the bag. The patch depicted in FIG. 3 is a cut single sheet of paper, or paper like substance, where the edges are cut straight or alternatively in a jaggety pattern (not shown), and the wall of the bag which is attached over the handle. Although such a patch does reinforce the connection of the handle to the wall, the patch of the prior art also has structural weakness. When the bag is picked up by one handle, as described above, the force at the edge where the handles meet the patch cause the patch to tear at points along the top edge 355. As shown in FIG. 7, the attachments points of the patch to the handle A, B, C, D receive the majority of the sheer forces. Thus, the forces on the patch at each of the four points A, B, C, and D is very high. As a result, the high force causes the patch to tear at any or all of points A, B, C and D. As an improvement in the art, the exemplary embodiments disclosed of present invention addresses this weakness.

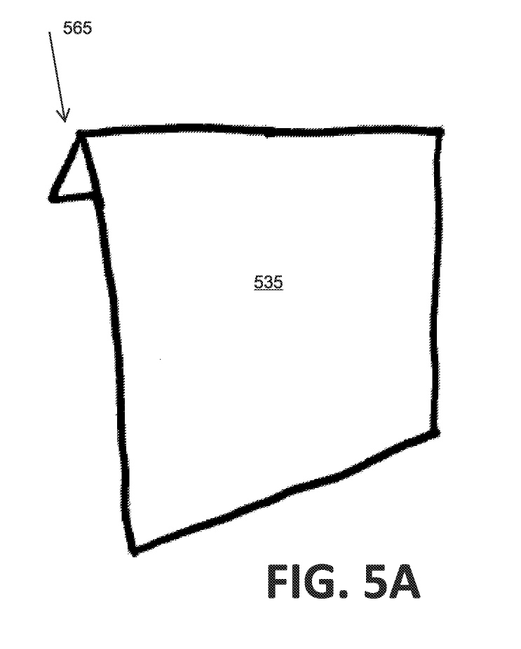

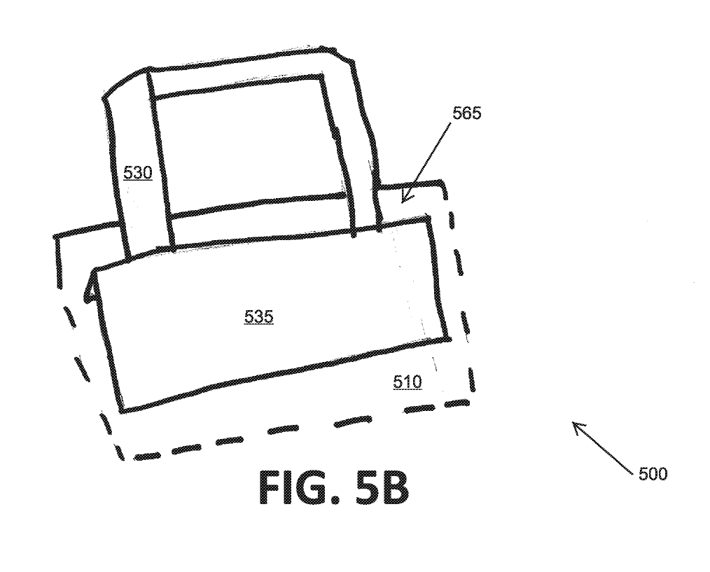

FIG. 5A is a picture illustrating an exemplary reinforcement patch 535 according to an embodiment of the present invention. As shown, the exemplary reinforcement patch is made of paper and includes a fold-over to define a folded top edge 565 of the patch. FIG. 5B is a picture illustrating the patch having the folded top end of FIG. 5A in registry with a handle 530 attached to the wall 510 of a paper bag 500 prior to affixing the patch to the outside of the handle and to the wall of the bag according to an exemplary embodiment of the present invention. As would be understood, affixing the patch to the handle and bag can be done with glue and other such permanent adhesives as is conventional in the art. Although the fold over is shown in towards the inside surface (i.e., the surface attached to the handle and wall), the fold-over can be in either direction, to the inside of the patch or to the outside of the patch.

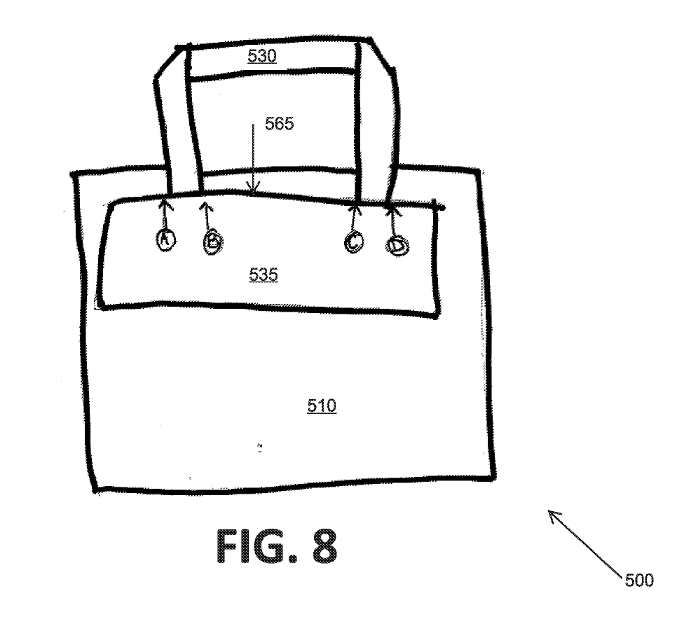

FIG. 8 is a picture illustrating a paper bag 500 with a handle 530 and a folded over patch 535 according to an embodiment of the present invention, now illustrating the focal points of forces that resist tearing at points A, B, C, D. As shown in FIG. 8, the fold-over top edge strengthens the top edge 565 of the patch 535 and impedes initial tearing of the handle at points A, B, C, and D of the patch when forces are applied to the edge, for example, when the bag is picked up by one handle, as described above. The fold-over at the top of the patch can consist of any fold-over length. Moreover, the fold-over can be one fold-over or multiple layers of fold-overs.

The fold-over top edge functions to resist the initial tear at the intersection of the handle and the patch and the wall 510. In particular, the fold-over construction strengthens the top edge of the patch and resists tearing of the patch at the intersection of the handle and the patch by absorbing shear forces and redistributing them along the length of the fold. Such shear forces are applied to the top edge of the patch, for example, when a user picks up the bag with one handle.

The exemplary bag construction with the folded-over patch provides new and unexpected results over the existing patch constructions, namely, significantly improved tear resistance when a handle is pulled away from the wall of the bag in a direction which normally would peel the handle away from the bag wall. Empirically, inventor tests have shown that the fold-over of any thickness patch works better, and more efficiently, than doubling the number of single-cut patches on top of each other, or doubling the thickness of the patch itself. For example, a fold-over of a 70 lb basis weight paper patch has been found to be much stronger than using two separate 70 lb basis weight paper patches on top of each other, with no fold-over. In addition, a single fold-over of a 70 lb basis weight paper patch has been found to be much stronger than using one 140 lb basis weight paper patch with no fold-over. Accordingly, it can be appreciated that the exemplary paper bag construction having handles and fold-over reinforcement patches provide a paper bag construction with substantially improved tear resistance over the existing paper bag constructions and without having to resort to multiple ply materials, alternative materials, or more complex manufacturing practices. It can also be appreciated that the improved tear resistance of the fold-over patch configuration further enables lower weight paper to be used so as to provide a bag with handles having sufficient strength while conserving resources and cost. Although an exemplary basis weight of 70 lb has been described, it can be appreciated that alternative weight paper can be used to construct a paper bag with handles without departing from the scope of the present invention.

The subject matter described above is provided by way of illustration only and should not be construed as limiting. For example, although the exemplary embodiments are described in the context of paper bag constructions having handle reinforcement patches that are also constructed from paper, it can be appreciated that alternative materials can be used for the bag and/or the reinforcement patch without departing from the scope of the present invention. Moreover, it can be appreciated that the disclosed embodiments can be applied to a variety of bag constructions having handles and requiring handle reinforcement by way of patches.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,”, “including,” “having,” “containing,” “involving,” and variations thereof when used in this specification, specify the presence of stated features, integers, steps, operations, elements, and/or components, but do not preclude the presence or addition of one or more other features, integers, steps, operations, elements, components, and/or groups thereof.

Various modifications and changes can be made to the subject matter described herein without following the exact details of the embodiments illustrated and described herein, and without departing from the true spirit and scope of the present invention, which is defined in the claims that follow.

What is claimed:

1. A paper bag construction having reinforced handle attachments, comprising:
a bag body having a top end and an opposing bottom end and one or more side walls extending between the bottom end and the top end in a vertical direction, wherein the one or more sidewalls define a hollow interior of the bag body that is closed at the bottom end and open at the top end;
a handle affixed to an exterior surface of the bag body at a first attachment area and a second attachment area proximate to the top end of the bag body and extending therefrom in the vertical direction beyond the top end of the bag body; and
a reinforcing patch overlaying the first and second attachment areas, wherein the reinforcing patch is affixed to both the handle and the exterior surface of the bag body;
the reinforcing patch comprising a sheet of material that is folded-over to define a top edge and wherein the reinforcing patch is affixed such that the top edge is oriented generally perpendicular to the vertical direction and the folded-over top edge is proximate to the top end of the bag body.

2. The paper bag construction of claim 1, wherein the reinforcing patch is attached to at least an outside surface of the handle at the first and second attachment areas and portions of the exterior surface of the bag body that are adjacent to each of the first and second attachment areas.

3. The paper bag construction of claim 1, wherein the handle comprises an elongate strip of material having a first end portion and a second end portion that each have an inside surface and an outside surface, wherein the inside surface of the first and second end portions are adhered to the exterior surface of the bag body to define the first and second attachment areas respectively, and wherein each of the first and second end portions of the handle have a left edge and a right edge that are generally oriented in the vertical direction and the respective end portion extending there-between.

4. The paper bag construction of claim 3, wherein the reinforcing patch is attached to at least the outside surface of the handle at the first and second end portions and is attached to a portion of the exterior surface of the bag body adjacent to at least at the first and second edges.

5. The paper bag construction of claim 2, wherein the reinforcing patch is attached to at least the outside surface of the handle at the first and second end portions and is attached to a portion of the exterior surface of the bag body surrounding the first and second attachment areas.

6. The paper bag construction of claim 1, wherein the reinforcing patch comprises two reinforcing patches, wherein each reinforcing patch is adhered to the handle at a respective one of the first and second attachment areas and at least two respective portions of the exterior surface of the bag body adjacent to the respective one of the attachment areas.

7. The paper bag construction of claim 1, wherein the folded-over top edge of the reinforcement patch absorbs shear forces and redistributes them along the length of the folded-over top edge so as to resist tearing of the patch at the intersection of the handle and the patch.

8. The paper bag construction of claim 1, wherein the sheet of material is folded-over a plurality of times to define the folded-over top edge.

9. The paper bag construction of claim 1, wherein the handle and the reinforcing patch are affixed using a permanent adhesive.

10. The paper bag construction of claim 1, further comprising a second handle attached to the bag body and a second reinforcing patch for reinforcing the attachment of the second handle to the bag body.

11. A method of manufacturing a paper bag having reinforced handle attachments, the method comprising:
providing a bag body having a top end an opposing bottom end and one or more side walls extending between the bottom end and the top end in a vertical direction, wherein the one or more sidewalls define a hollow interior of the bag body that is closed at the bottom end and open at the top end;
adhering a first and a second end portion of an elongate handle to an exterior surface of the bag body proximate to the top end of the bag body at a first attachment area and a second attachment area, respectively, such that the handle is configured to extend from the first and second attachment areas generally in the vertical direction beyond the top end of the bag body;
folding a first section of a sheet of material over a second section of the sheet to define a reinforcing patch having a folded-over top edge;
applying an adhesive to an inside surface of the folded-over reinforcing patch;
placing the reinforcing patch in registry with the handle such that the patch overlays the first and second attachment areas and the folded-over top edge is oriented generally perpendicular to the vertical direction and is proximate to the top end of the bag body;
affixing the reinforcing patch to the handle and the exterior surface of the bag body, wherein the reinforcing patch is adhered to an outside surface of the handle and portions of the exterior surface of the bag body that are adjacent to the first and second attachment areas.

12. The method of claim 11, wherein the handle comprises a first end portion and a second end portion, wherein the inside surface of the handle at the first and second end portions are adhered to the exterior surface of the bag body to define the first and second attachment areas respectively, and wherein each of the first and second end portions of the handle have a left edge and a right edge that are generally oriented in the vertical direction and the respective end portion extending there-between.

13. The method of claim 12, wherein the reinforcing patch is attached to at least the outside surface of the handle at the first and second end portions and is attached to a portion of the exterior surface of the bag body adjacent to at least at the first and second edges.

14. The method of claim 12, wherein the reinforcing patch is attached to at least the outside surface of the handle at the first and second end portions and is attached to a portion of the exterior surface of the bag body surrounding the first and second attachment areas and there-between.

15. The method of claim 11, wherein the reinforcing patch comprises two reinforcing patches, wherein each reinforcing patch is adhered to the handle at a respective one of the first and second attachment areas and at least two respective portions of the exterior surface of the bag body adjacent to the respective one of the attachment areas.

16. The method of claim 11, wherein the folded-over top edge of the reinforcement patch absorbs shear forces and redistributes them along the length of the folded-over top edge so as to resist tearing of the patch at the intersection of the handle and the patch.

17. The method of claim 11, wherein the sheet of material is folded-over a plurality of times to define the folded-over top edge.
